(19) United States
(12) Patent Application Publication
(10) Pub. No.: US 2026/0327101 A1
(43) Pub. Date: Oct. 22, 2026

(54) Uniform Magnetic Desalination and Organophobic Ceramic Membrane System and Method

(71) Applicant: Felipe Lembcke, Granbury, TX (US)

(72) Inventor: Felipe Lembcke, Granbury, TX (US)

(73) Assignee: Molecular Filtration, Inc., Granbury, TX (US)

(21) Appl. No.: 19/430,586

(22) Filed: Dec. 23, 2025

(51) Int. Cl. C02F 1/48; B01D 69/02; B01D 71/02; C02F 1/44; C02F 101/30; C02F 103/08; C02F 103/10

(52) U.S. Cl. CPC C02F 1/484; B01D 69/02; B01D 71/02; C02F 1/44; C02F 2101/30; C02F 2103/08; C02F 2103/10

(57) ABSTRACT

A system and method for treating contaminated water using uniform magnetic desalination combined with an organophobic ceramic membrane are disclosed. A controlled magnetic field is applied to influent water to promote ion alignment, particle aggregation, and modification of scaling behavior prior to membrane filtration. The conditioned water is directed to an organophobic ceramic membrane module configured to selectively reject non-polar organic contaminants while allowing permeation of water and selected dissolved species. The combined magnetic conditioning and membrane separation reduce fouling, improve contaminant rejection efficiency, and enhance operational stability. The system is applicable to industrial wastewater, produced water, semiconductor process water, and desalination streams, providing improved removal of organic and inorganic contaminants with reduced scaling and extended membrane life.

### CROSS-REFERENCE TO RELATED APPLICATIONS

This application expressly relies upon and incorporates by reference International Patent Application No. WO 2015/066347, entitled “Separation of Organic Compounds from Liquid,” published May 7, 2015, in its entirety.

### FIELD OF THE INVENTION

The present invention relates generally to water treatment technologies and, more particularly, to systems and methods for simultaneous desalination and non-polar organic compound removal using organophobic ceramic membranes in combination with substantially uniform magnetic fields.

### BACKGROUND OF THE INVENTION

Produced water, flowback water, and frack water generated during oil and gas operations contain high concentrations of dissolved salts and non-polar organic contaminants.

Conventional desalination systems primarily target dissolved salts and typically require separate pretreatment steps to remove organic contaminants.

Organophobic ceramic membranes are known to reject non-polar organic compounds while allowing water permeation, but do not actively influence ionic transport.

Magnetic water treatment systems have been proposed for scale mitigation and ion manipulation but have not been integrated with membrane-based separations.

Accordingly, there remains a need for an integrated system capable of simultaneously concentrating ions and removing non-polar organic compounds in a single treatment module.

### SUMMARY OF THE INVENTION

The present invention provides a treatment system integrating an organophobic inorganic ceramic membrane with multiple substantially uniform magnetic field regions aligned with membrane flow channels.

The magnetic field regions are configured to modify ionic hydration and transport behavior, accelerating ionic species and promoting axial ion concentration within the membrane channels.

Simultaneously, the organophobic ceramic membrane selectively rejects non-polar organic compounds while allowing water permeation.

The combined effects enable simultaneous desalination and organic contaminant removal within a single module.

### DETAILED DESCRIPTION OF THE INVENTION

A saline or contaminated feed stream is introduced into an organophobic inorganic ceramic membrane module comprising a plurality of longitudinal flow channels.

Multiple opposed magnetic field sources are positioned around the membrane module to generate a plurality of substantially uniform magnetic field regions aligned with the longitudinal axes of the flow channels.

In certain embodiments, four substantially uniform magnetic field regions overlap within the membrane module to form an extended zone of uniform magnetic flux density.

Without being bound by theory, ionic species flowing through the membrane channels experience magnetic forces related to charge and velocity, increasing ionic residence time and promoting axial ion concentration.

Water permeates transversely through the organophobic ceramic membrane while non-polar organic compounds are rejected, producing a purified permeate stream and a concentrated retentate stream.

The membrane module housing is formed from a non-magnetic, chemically resistant polymer material.

In preferred embodiments, the housing material comprises polyether ether ketone (PEEK) to preserve magnetic field uniformity.

1. A method for treating saline water, comprising applying multiple substantially uniform magnetic field regions to a liquid flowing through an organophobic inorganic ceramic membrane to alter ionic transport behavior and promote axial ion concentration within membrane flow channels.

2. The method of claim 1, wherein the organophobic ceramic membrane selectively rejects non-polar organic compounds.

3. The method of claim 1, wherein water permeates through the membrane while ionic species are concentrated in a retentate stream.

4. The method of claim 1, wherein the magnetic field regions are generated by opposed magnetic field sources arranged in Helmholtz-type configurations.

5. A treatment system comprising an organophobic inorganic ceramic membrane module, multiple opposed magnetic field sources configured to generate overlapping substantially uniform magnetic field regions aligned with membrane flow channels, and a non-magnetic housing.

6. The system of claim 5, wherein the housing is formed from polyether ether ketone (PEEK).
